(19) United States
(12) Patent Application Publication
(10) Pub. No.: US 2005/0061133 A1
(43) Pub. Date: Mar. 24, 2005

(54) Apparatus for trimming unbound side edges of print products

(75) Inventor: Beat Marbacher, Nebikon (CH)

Correspondence Address: VENABLE, BAETJER, HOWARD AND CIVILETTI, LLP, P.O. BOX 34385, WASHINGTON, DC, 20043-9998, US

(73) Assignee: MULLER MARTINI HOLDING AG, Hergiswil (CH)

(21) Appl. No.: 10/912,543

(22) Filed: Aug. 6, 2004

(30) Foreign Application Priority Data
Aug. 7, 2003 (EP) 03405581.4

(51) Int. Cl. B26D 7/06

(52) U.S. Cl. 83/733

(57) ABSTRACT

An apparatus for trimming unbound side edges of a print product includes a plurality of trimming devices arranged at a distance to each other. A positioning device aligns the print product. A feeding device receives the print product from the positioning device and successively position the print product in a respective one of the trimming devices for a cut.

### CROSS-REFERENCE TO RELATED APPLICATION

This application claims the priority of European Patent Application No. b 03405581.4, filed on Aug. 7, 2003, the subject matter of which is incorporated herein by reference.

### BACKGROUND OF THE INVENTION

The invention relates to an apparatus for trimming unbound side edges of print products such as books, brochures or magazines, the apparatus comprising at least one trimming device, one positioning device for aligning the print products, and one feeding device. Apparatuses of this type are known in the print-processing industry and are used for trimming the top, bottom, and front edges of print products, for example books, brochures and magazines. As a rule, a print product with rough format is trimmed, for example, to the Formats A4 to A6.

European patent document EP 0 842 746 discloses a method and an apparatus for trimming unbound side edges of print products. With this method, the print products are gripped at the bound side edge by a positioning device and are supplied with a rotational and translational movement to a trimming device. The trimming device simultaneously trims two print products at the top and/or the bottom, wherein the two print products to be trimmed simultaneously must be of the same size. For that reason, this method is particularly suited for trimming large series of identical-size print products, but is less suited for use with small series, e.g. as produced with a digital printing process. In addition, the conversion to a print product having a different format is expensive and involved.

European patent document EP 0 710 530 A also discloses an apparatus for trimming unbound side edges of print products. The print products to be trimmed are gripped by a product gripper, which can be moved with a rotational and translational movement relative to the trimming knife. However, a conversion to a different format is time consuming with this apparatus as well. The device is therefore also not suitable for small series which can be produced cost-effectively, in particular with a digital printing technique.

### SUMMARY OF THE INVENTION

Thus, it is an object of the present invention to create an apparatus that is suitable for trimming comparably small numbers of print products. In particular, the apparatus should be suitable for trimming book blocks and books, as well as bound and stitched brochures and magazines, and should also be suitable for trimming print products having different rough format sizes.

The above and other objects are accomplished according to an exemplary embodiment of the invention in which an apparatus of the type first mentioned above is provided with several trimming devices, arranged at a distance to each other, and the feeding device is designed so that the print products to be trimmed can be positioned successively in each of the trimming devices for a cut.

With the apparatus according to the invention, the print products are aligned in the positioning device and are then supplied to the feeding device. The feeding device successively feeds the print products to the trimming devices where they are respectively positioned and where respectively one side cut is made. By using a suitable control for the feeding device, the apparatus can be used to trim different rough formats without requiring involved conversion measures, wherein smaller print product series can be trimmed as well. Smaller series of this type are produced in particular with digital printers.

The apparatus design can be particularly simple and economical if, according to one modification of the invention, the print products are aligned respectively along one (non-cut) side edge and the product back in the positioning device and are supplied by the feeding device to the trimming devices, without any change in this alignment. For this, the print products are preferably gripped along the back and/or a bound side edge. The sequence of steps is particularly advantageous if, according to another modification of the invention, the print products are essentially moved along a circular course by the feeding device, thus resulting in an apparatus that requires comparatively little space.

According to yet another modification of the invention, the print products aligned in the positioning device are gripped by a product gripper and are moved with a predetermined linear displacement movement to a transfer position. The alignment of the print products during the trimming operation thus corresponds to the alignment in the positioning device. The transfer consequently requires only a predetermined, linear movement and/or a displacement.

The apparatus according to the invention comprises a positioning device for aligning the print products to be trimmed, a feeding device, as well as several trimming devices that are arranged at a distance to each other. The feeding device is designed such that the print products to be trimmed can be positioned successively in each of the trimming devices for a cut.

A particularly advantageous embodiment is obtained if, according to another modification of the invention, the trimming devices are arranged along the periphery of a turntable, wherein the print products are preferably arranged on the turntable so that they do not change their alignment during the feeding. According to one modification, this is preferably achieved with an epicyclical and/or planetary gear, wherein the print products are preferably gripped by a product gripper which can be displaced for the positioning inside the trimming devices.

According to yet another modification of the invention, the product gripper is displaced with the aid of control members.

Additional and advantageous features follow from the dependent patent claims, the following description and the drawing.

### BRIEF DESCRIPTION OF THE DRAWINGS

One exemplary embodiment of the invention is explained in further detail in the following with the aid of the drawing, showing in:

FIG. 1 shows schematically a three-dimensional view of an apparatus according to the invention.

FIG. 2 shows schematically the individual positions of the print products during the alignment, the trimming, and the discharge.

FIG. 3 shows schematically a three-dimensional view of the positioning device.

FIG. 4 shows schematically a three-dimensional view of the feeding device.

FIG. 5 shows schematically a three-dimensional view of a product grippe.

FIG. 6 shows schematically a three-dimensional view of a trimming device.

FIGS. 7a-7d show schematically the mode of operation of the trimming device.

FIG. 8 shows schematically a three-dimensional view of the discharge device.

### DETAILED DESCRIPTION OF THE INVENTION

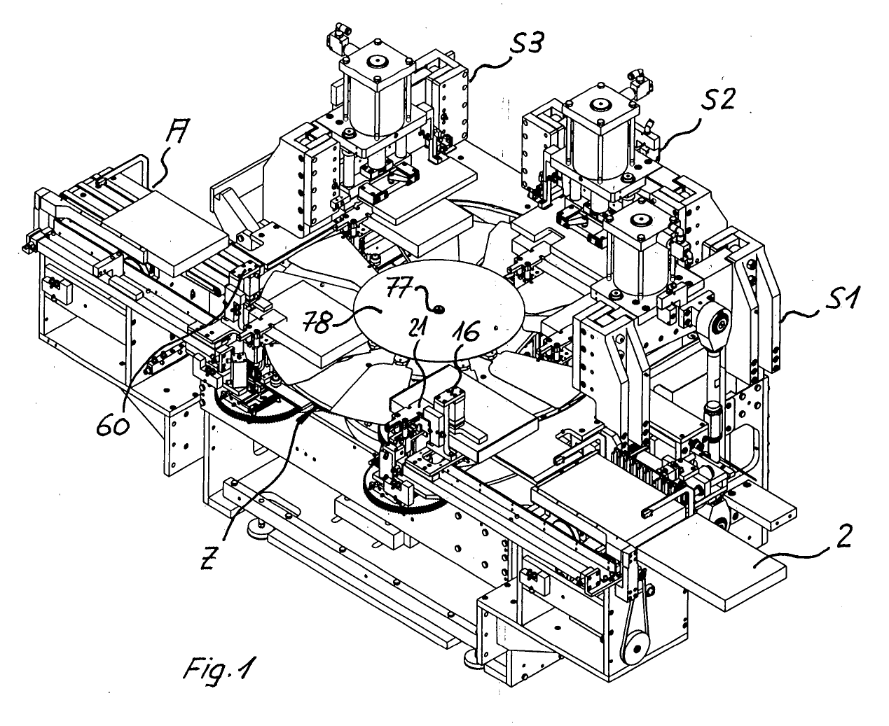

Referring to FIG. 1, there is shown an apparatus 1 which is used for trimming print products 2 supplied to apparatus 1 in a rough format. Print products 2 are perfect-bound book blocks, for example, or stitched or otherwise bound brochures or magazines and the like. Apparatus 1 comprises a positioning device P in which the as yet untrimmed print products 2 are aligned. Following the positioning, the print products 2 are displaced by a certain amount in a linear direction with an intake gripper 16 and are then transferred to a product gripper 21. With the aid of a feeding device Z, the print product 2 is then successively fed to a first trimming device S1, a second trimming device S2, and a third trimming device S3. The print product 2′″, which is trimmed along three sides, is finally supplied to a discharge device A. From this discharge device A, the trimmed product is moved to different processing stations or is shipped.

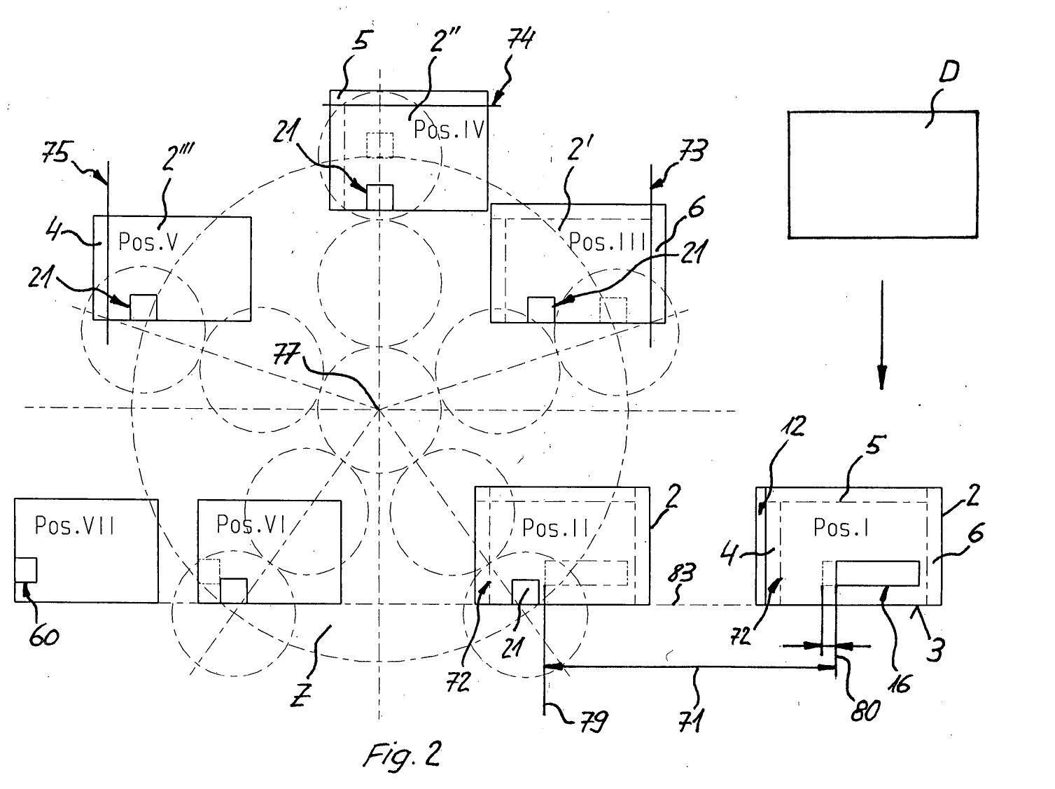

When feeding the print products 2 to the individual trimming devices S1 to S3 and then to the discharge device A, the alignment of the print products 2 is not changed, as is clearly shown in FIG. 2. The alignment is also not changed if the print product 2 is transported from the positioning device P by the intake gripper 16 to the product gripper 21, wherein the displacement 71 for the transport given in FIG. 2 is linear as well as horizontal. In addition, the displacement can also be adapted to the top cut in the trimming device S3. The end position 80, shown in FIG. 2, can be adjusted by correspondingly changing the displacement 71. FIG. 2 shows that the print products 2 to be trimmed pass through seven positions and/or stations. In position I, the print products 2 are aligned, while in position II, which is a transition position, the print products 2 are gripped by the product gripper 21. In position III, the bottom of print product 2 is trimmed by cutting a bottom section 6 off the print product 2. The print product 2′, which has been trimmed on one side, is then supplied to the position IV where the front section 5 is trimmed off. The print product 2″ that has been trimmed on two sides is supplied to the position V where a top section 4 is cut off. The print product 2′″, which is now trimmed on all three sides, is then transported to the position VI where it is gripped by a discharge gripper 60 and transferred to the position VII where the print product 2′″ is transported away. In the positions III and IV, the print products 2 are respectively displaced with a controlled movement and positioned precisely for the respective trimming step. The product is displaced corresponding to the format and the width of cut-off sections 6 and 5. The adjustment of the position of intake gripper 16, determines the displacement 71 and width of the section 4 that is trimmed off the top edge. As a result of the individual positioning, it is also possible to process different formats without requiring extensive conversion operations.

The print products 2 that must be aligned in the positioning device P have not yet been trimmed and thus have a rough format. These print products 2 are produced in a printing machine D, which is only indicated schematically in FIG. 2. As a rule, a device for folding and binding the printed sheets or signatures is provided between the printing machine D and the positioning device P. These devices, which are known per se, are not shown herein. The printing machine D is preferably a digital printer which allows the production of small series. The apparatus 1 is configured such that copies of print products 2 with different formats can be processed successively, essentially without conversion operations.

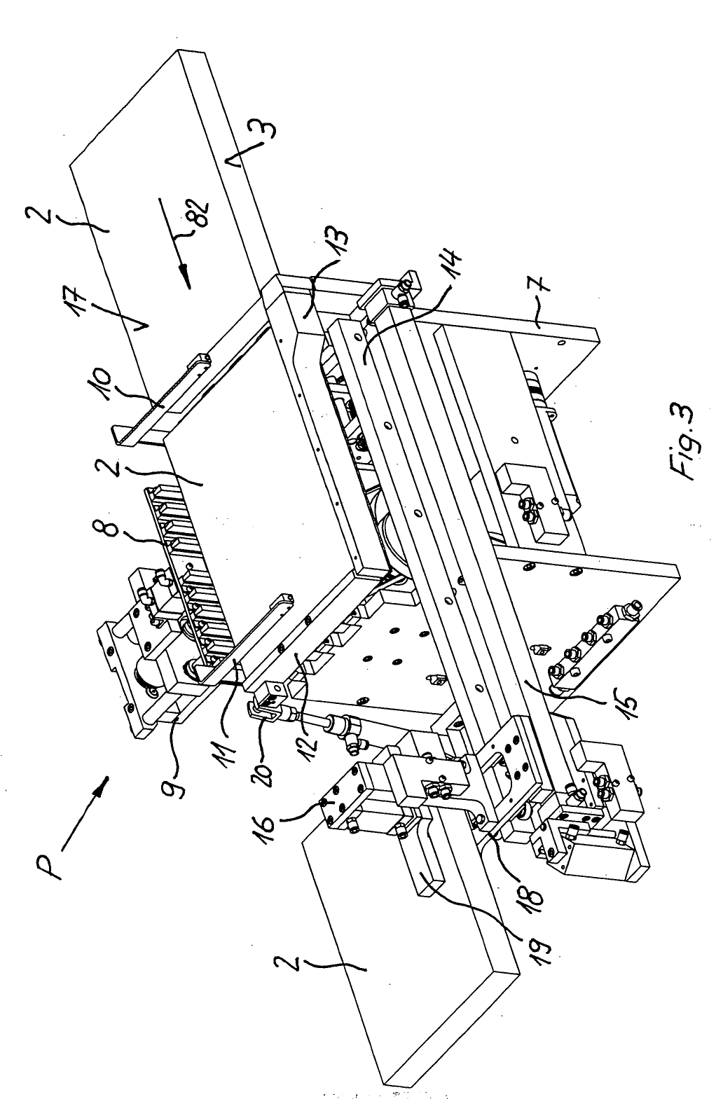

According to FIG. 3, the positioning device P is provided with a frame 7 with thereon arranged end stops 12 and 13 for aligning the print product 2. In FIG. 3, the print products 2 are supplied respectively in the direction of arrow 82. The back 3 of the printed product extends parallel to the direction of arrow 82. The top 17 of print product 2 in this case is aligned horizontally. The print product 2 is fed to the positioning device P with the aid of a known transporting device, not shown herein, for example a belt conveyor. Of course, a specific timing is used for the feeding as well as the further processing, which is generally predetermined by the printing machine D.

A slider 8 with a lift drive 9 is provided for positioning the print products 2 against the end stop 13 along the back 3. The print products 2 are fitted against the end stop 13 with this slider 8 as soon as the top of the print product 2 is positioned against the end stop 12. The end stop 12 extends crosswise to the direction of arrow 82 and can be displaced vertically between the working position, shown in FIG. 3, and a lower retracting position by means of a control cylinder 20.

If a print product 2 is aligned against the end stops 12 and 13, the end stop 12 is moved down into the retracted position and the print product 2 is gripped by the intake gripper 16. The intake gripper 16 is positioned such that it can be displaced along a guide 14, meaning it can traverse to a limited degree back and forth along this guide 14 with the aid of a drive 15, e.g. a control cylinder. FIG. 3 shows the intake gripper 16 in a position in which a print product 2 is removed from the support on the frame 7, wherein the alignment of product 2 is not changed during this linear horizontal movement, as can be seen.

For gripping the print product 2, the intake gripper 16 is provided with a height-adjustable upper jaw 19, as well as a sliding carriage 18. The product 2 is clamped in between the jaw 19 and the sliding carriage 18. Once the aligned print product 2 moves away, the end stop 12 again moves upward into the position shown in FIG. 3, so that a following print product 2 can be aligned. The displacement 71 can be adjusted, as mentioned, for the top trimming. The end positions 79 and 80 of the intake gripper 16 are shown in FIG. 2. The virtual top trimming edge is drawn in with a dash-dot line 72 in positions I and II. The intake gripper 16 positions the print product 2 in the position II, such that the virtual top trimming edge 72 extends through the product 2 corresponding to the intended width of the trimming section 4 on the top.

In the position II, the print product 2 is gripped by the product gripper 21. The intake gripper 16 opens up automatically and moves back to the position I where it grips the following product 2. The transfer of product 2 in position II from the intake gripper 16 to the product gripper 21 occurs without change in the alignment of print product 2. In position II and in position I, the transfer furthermore occurs such that the back 3 extends along a joint line 83.

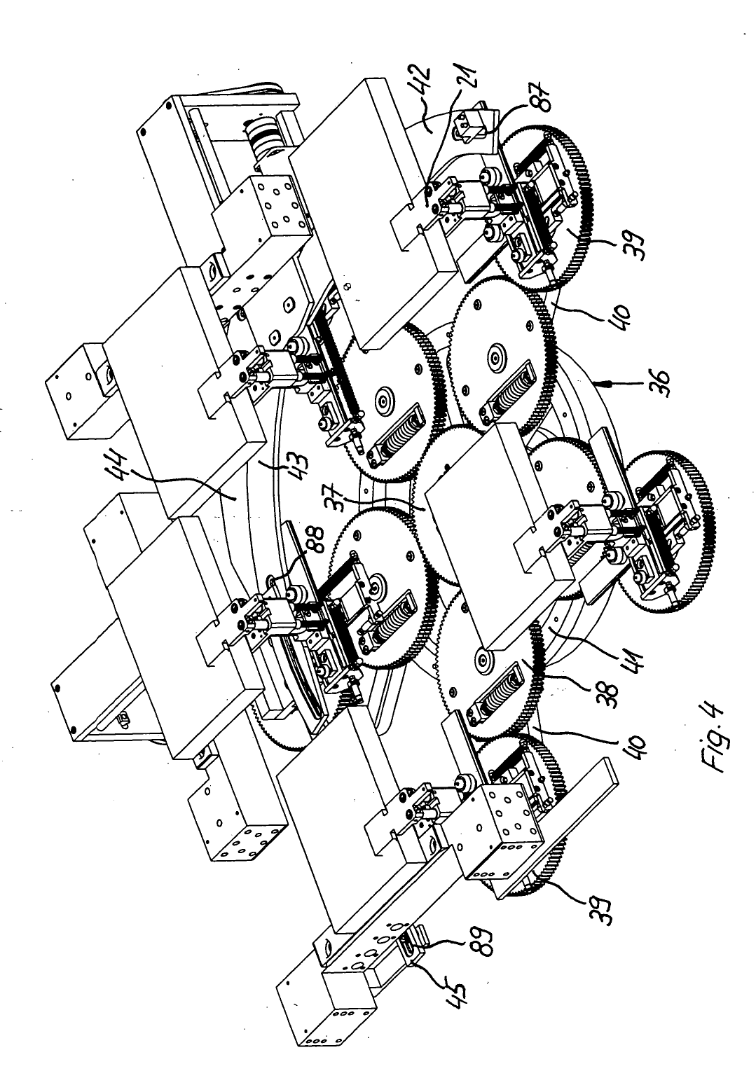

The print product 2 is moved with the feeding device Z from the position II to the position III. This movement occurs in counter-clockwise direction around a vertical axis 77, wherein the movement could also be in clockwise direction with a corresponding apparatus. The angle of rotation in the present case is 72°. To realize this movement, the product gripper 21 is arranged on a spur gear 39 of a planetary gear 36, as shown in FIG. 4. The epicyclical and/or planetary gear 36 is a five-fold gear, provided with a fixedly connected central gear 37, five rotating intermediate gears 38, as well as five rotating outer spur gears 39. The intermediate gears 38 are positioned rotating on a gearwheel 41. The spur gears 39 are respectively positioned on a web 40. The translation ratio is respectively 1:1, so that during the rotation, the alignment of the spur gears 39 always remains the same. Accordingly, the product grippers 21 and the therewith gripped print products 2 always have the same alignment during the rotation. Thus, the back is always parallel to line 83 in FIG. 2. The planetary gear 36 forms a turntable 67, which is partially covered by a disc-shaped cover 78 (FIG. 1).

A product gripper 21 is positioned on each spur gear 39. On the whole, five product grippers 21 are provided which can be moved by the planetary gear 36 in counter-clockwise and/or clockwise direction. The product grippers 21 are respectively moved synchronously and/or are stopped simultaneously.

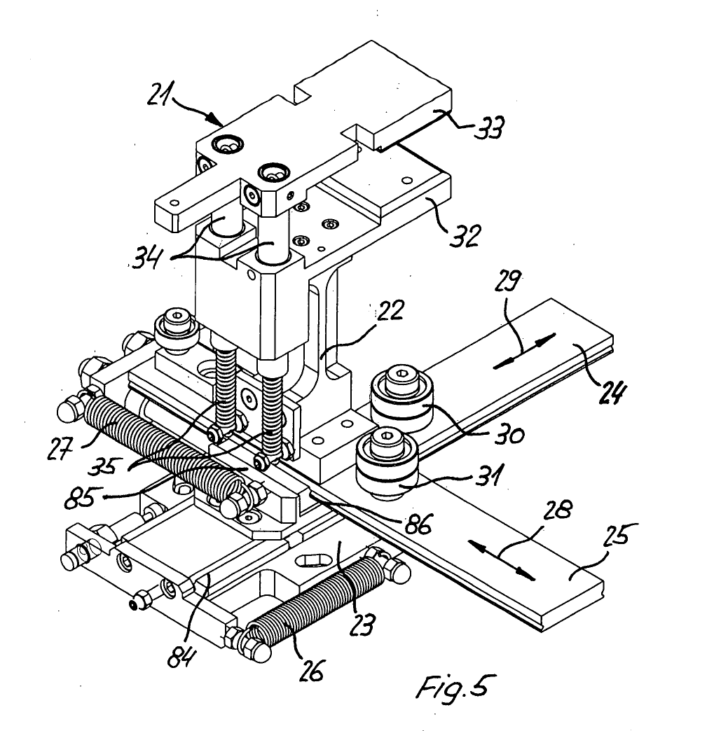

The product grippers 21 have identical designs. FIG. 5 shows that the product grippers 21 are provided with a base plate 23 which is mounted on one of the spur gears 39. The base plate 23 contains a guide groove 84 in which a first slider 24 is positioned such that it can be displaced. The slider 24 can be displaced in the directions of double arrow 29, by means of a roll 30 that is positioned on the slider 24, as can be seen. The displacement in FIG. 5 toward the bottom left occurs as a result of the counteracting force of a tension spring 26. An additional plate 85 is mounted on the first slider 24, which also contains a guide groove 86. This guide groove 86, however, extends at a right angle to the groove 84. A second slider 25 that can be displaced in the directions of double arrow 28 is positioned displaceable inside this additional groove 86. Again, the displacement occurs by means of a roll 31, which is positioned on the slider 25. According to FIG. 5, the second slider 25 can be displaced toward the upper left and counter to the resetting force of a tension spring 27. A support 22 is mounted on the second slider 25 which forms a fixed lower clamping jaw 32 on which an upper clamping jaw 33 is positioned so as to be height-adjustable with two guide rods 34. The clamping effect is ensured with the aid of tension springs 35. Pneumatic means can be used, for example, for lifting the upper clamping jaw 33 and opening the product gripper 21.

The two sliders 24 and 25 extend at a right angle to each other, as previously mentioned. The upper slider 25 extends parallel to the back 3 and the lower slider 24 extends parallel to the top edge and the bottom edge of the gripped print product 2. By displacing the sliders 24 and 25, the print product 2 can thus be displaced parallel to the back 3 or transverse to it, wherein the alignment is maintained.

Control members 42 to 45 are arranged along the periphery of the planetary gear 36 for displacing the sliders 24 and 25. These control members 42 to 45 engage in the roll 30 or 31 for the displacement. The control members 42 to 45 are positioned displaceable in elongated holes 87 to 89, wherein the drive for displacing the control members 42 to 45 is not shown herein. The control member 42 functions to advance the sliders 25 for the bottom cut and the control member 43 functions to return the slider 25 to its original position. The control member 44 functions to advance the slider 24 for the front cut and the control member 45 serves to reset the slider 24. For the movement of product gripper 21 from position II to position III, the control member 42 operates jointly with the roll 31, thus positioning the print product 2 precisely in the trimming device Si. Once the print product 2 is correctly positioned in the trimming device S1, the feeding device Z and/or the planetary gear 36 are stopped in order to realize the trimming operation. Following the completion of the trimming operation, the print product 2′, which is trimmed on one side, is moved to the position IV. The slider 25 is returned to the starting position with the control member 43. At the same time, the control member 44 positions the print product 2′ in the second trimming device S2 for the front cut. Once the print product 2′ is positioned in the second trimming device S2, a front cut is carried out with the trimming device S2, wherein the feeding device Z is again stopped for this operation.

The print product 2′′, which is now trimmed on two sides, is then moved further in counter-clockwise direction by 72° to the third trimming device S3. During this movement, the control member 45 moves the slider 24 back. No advancement is required for the top cut since the corresponding position is already fixed by the end position selected in position II.

Once the top is trimmed in the trimming device S3, the print product 2′″ which is trimmed on three sides is moved to the position VI, wherein this movement is also a counter-clockwise movement by 72°. In the position VI, the back 3 is positioned along the line 83, as shown in FIG. 2.

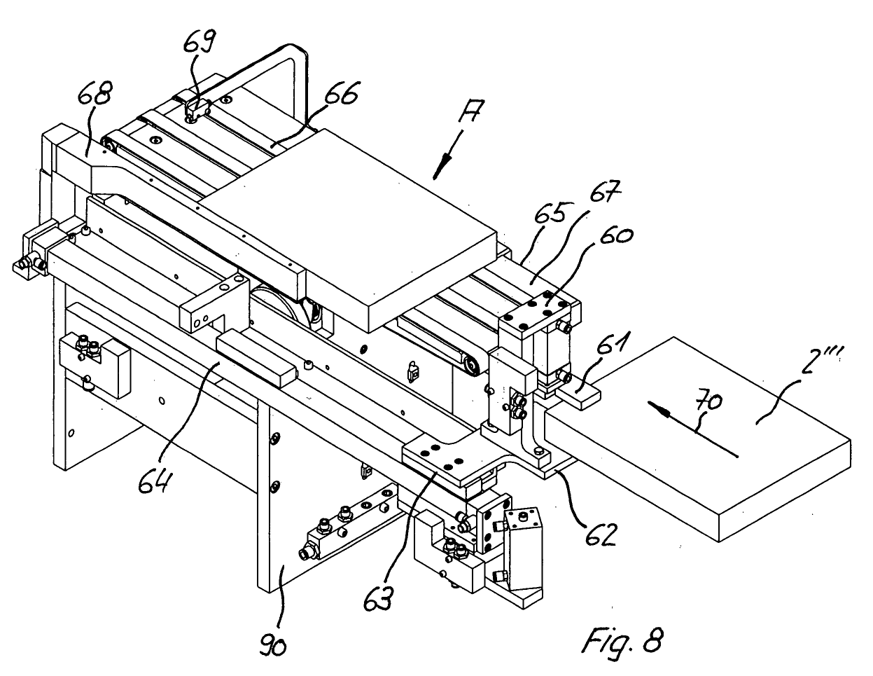

The print product 2′″ is then transferred to the discharge device A, which comprises a frame 90 with thereon arranged transporting device 65, as shown in FIG. 8. This transporting device 65 has a table 67 around which transport belts 66 are fitted. In addition, the table 67 is provided with an end stop 68 on the side. According to FIG. 8, the trimmed print product 2′″ is transferred to the transport device 65 in the direction of arrow 70. A discharge gripper 60 is provided for this, which can be moved with the aid of a slide carriage 63 in the direction of arrow 70 as well as in the opposite direction. The discharge gripper 60 is moved back and forth with the aid of a drive 64. In order to grip the print product 2′″, the discharge gripper 60 is provided with a lower clamping plate 62 as well as a clamping jaw 61 for gripping the top of print product 2′″, as shown in FIG. 8, and for moving it onto the transporting device 65, wherein the alignment of the print product is again preserved. Once the print product 2′″ is positioned on the transporting device 65, the discharge gripper 60 opens up and moves back to the starting position shown in FIG. 8. The feeding device Z is stopped while the print product 2′″ is moved onto the transport device 65. During this transport, a rough print product 2 is simultaneously moved from position I to position II as shown in FIG. 2. Corresponding trimming steps are realized at the same time at the three trimming devices S1 to S3. These actions are synchronous and are controlled by a control device not shown herein.

If a print product 2 with a different format is to be trimmed, the control members 42 to 45 are changed accordingly and the displacement 71 is also adapted to the new format. The conversion can occur automatically with the aforementioned control device and suitable adjustment drives.

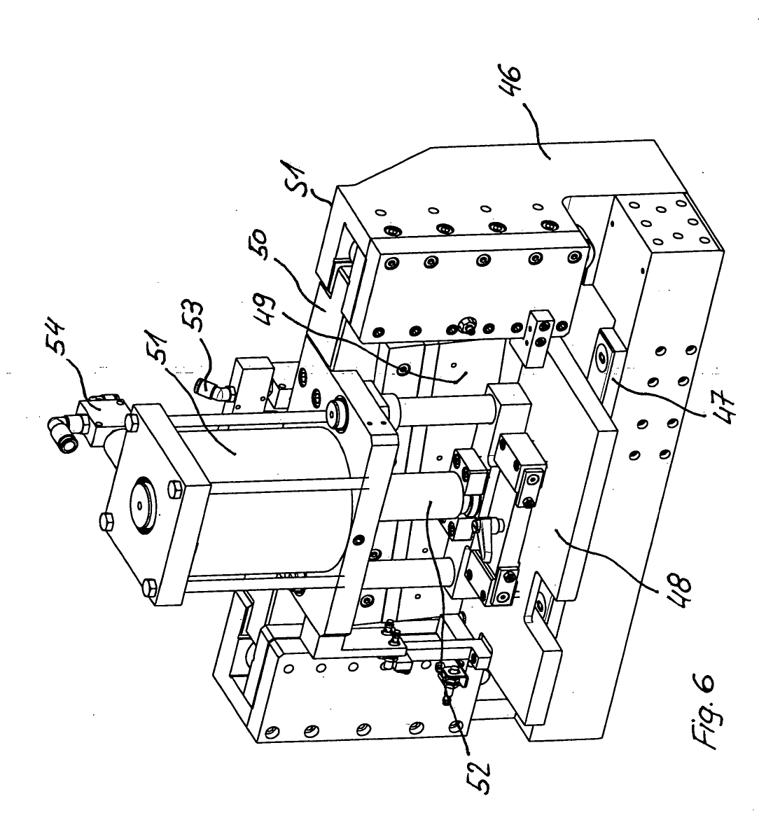

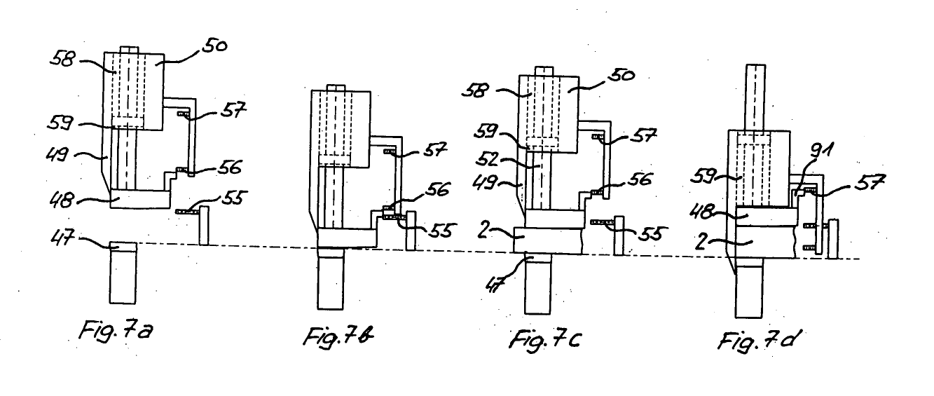

In the following, the mode of operation of the trimming devices S1 to S3 is explained with the aid of FIGS. 6 and 7a to 7d. These trimming devices S1 to S3 are preferably identical in design.

The trimming device S1 in FIG. 6 is provided with a housing 46 on which is disposed a lower knife 47 that is rigidly connected to the frame, as well as a vertically movable knife holder 50 with an upper knife 49. In addition, a pressure plate 48 is positioned at the lower end of a piston rod 52 of a pressure cylinder 51. The pressure cylinder 51 has an upper pressure chamber 58, as shown in FIGS. 7a-7d, and a lower pressure chamber 59 with connections 53 and 54. In addition, a first initiator 56 and a second initiator 57 are connected to the knife holder 50. A third initiator 55 has a fixed position with respect to the lower knife 47. FIG. 7a shows the starting position where the knife holder 50 is at an upper dead point. If the trimming device S1 is activated while no print product 2 is positioned therein, the pressure plate 48 moves downward. However, no pressure is exerted onto the pressure plate 48 since the first initiator 55 responds in the corresponding position and the pressure balance between the upper pressure chamber 58 and the lower pressure chamber 59 is maintained.

If the trimming device S1 contains a print product 2 with the defined thickness range as shown in FIG. 7c, then the pressure plate 48 moves downward. The first initiator 55 in that case does not respond. However, the second initiator 56 responds and the lower pressure chamber 59 in the pressure cylinder 51 is thus ventilated. As a result of the still existing pressure in the upper chamber 58, a pressure is built up that is exerted onto the pressure plate 48 and this pressure plate 48 subsequently clamps the print product 2 onto the lower knife 47. The knife holder 50 with the upper knife 49 can then move downward with the aid of a drive, not shown herein, for the trimming operation. In that case, the pressure cylinder 51 with the knife holder moves downward. Following the upward movement of the knife holder 50, the starting position according to FIG. 7a is reached once more.

FIG. 7d shows a trimming device Si with therein positioned print product 2, for which thickness exceeds the defined range. In accordance with the higher thickness, a part 91 on the pressure plate 48 is positioned at the respective height. Once the pressure plate 48 rests against the excessively thick product 2, the third initiator 57 responds and a corresponding signal will immediately stop the trimming device S1.

The invention has been described in detail with respect to referred embodiments, and it will now be apparent from the foregoing to those skilled in the art, that changes and modifications may be made without departing from the invention in its broader aspects, and the invention, therefore, as defined in the appended claims, is intended to cover all such changes and modifications that fall within the true spirit of the invention.

1. An apparatus for trimming unbound side edges of a print product, comprising:
a plurality of trimming devices arranged at a distance to each other;
a positioning device for aligning the print product; and
a feeding device receiving the print product from the positioning device and successively positioning the print product in a respective one of the trimming devices for a cut.

2. The apparatus according to claim 1, wherein the positioning device comprises a respective end stop for at least one of a top, bottom and back of the print product to be trimmed.

3. The apparatus according to claim 1, further comprising at least one intake gripper to grip the print product at the positioning device and to move the print product to a transfer position on the feeding device.

4. The apparatus according to claim 1, wherein the feeding device comprises a turntable on which the print product is supplied to the trimming devices without change in alignment of the print product.

5. The apparatus according to claim 1, wherein the feeding device includes control members with which the print product can respectively be positioned in the trimming devices.

6. The apparatus according to claim 1, wherein the feeding device includes a manifold planetary gear for moving the print products to be trimmed.

7. The apparatus according to claim 6, wherein the planetary gear comprises a five-fold gear for moving the print product successively through five positions including an initial transfer position, three positions each for respectively one side cut, and a position for discharge of the print product.

8. The apparatus according to claim 1, wherein the feeding device includes at least one product gripper which does not change its alignment during feeding of the print product to thus maintain the alignment of the gripped print product.

9. The apparatus according to claim 8, wherein the feeding device includes a controller and the product gripper includes two sliders, moving at a right angle to each other, which operate jointly with the controller for positioning the print product in the trimming device.

10. The apparatus according to claim 1, wherein each trimming device is respectively provided with a pressure plate and further comprising respective initiators to control the pressing force of the each pressure plate, depending on the position of the pressure plate.
